(19) United States
(12) Patent Application Publication
(10) Pub. No.: US 2025/0389393 A1
(43) Pub. Date: Dec. 25, 2025

(54) STORAGE ASSEMBLY FOR STORING PRESSURISED FLUID, SUCH AS HYDROGEN

(71) Applicant: TENARIS CONNECTIONS B.V., Amsterdam (NL)

(72) Inventors: Matteo Ortolani, Dalmine (Bergamo) (IT); Michele Sileo, Dalmine (Bergamo) (IT); Paolo Bortot, Dalmine (Bergamo) (IT)

(21) Appl. No.: 18/881,237

(22) PCT Filed: Jul. 5, 2023
(86) PCT No.: PCT/EP2023/068518

§ 371 Date: Jan. 3, 2025

(30) Foreign Application Priority Data
Jul. 6, 2022 (NL) 2032390

(51) Int. Cl. F17C 13/08

(52) U.S. Cl. CPC F17C 13/08; F17C 2201/0119; F17C 2201/035; F17C 2205/0103; F17C 2205/013; F17C 2209/22; F17C 2221/012; F17C 2260/04; F17C 2265/065; F17C 2270/0139

(57) ABSTRACT

Storage assembly for storing pressurised fluid, such as hydrogen, which storage assembly comprises at least one cylindrical primary pressure vessel configured to store pressurised fluid at a first pressure and having a first longitudinal length, at least one cylindrical secondary pressure vessel configured to store pressurised fluid at a second pressure and having a second longitudinal length, a primary support supporting, a secondary support, and a shared support, and also a method for producing such a storage assembly.

### FIELD OF THE INVENTION

The invention relates to a storage assembly for storing pressurised fluid, such as hydrogen, and a method for producing said storage assembly.

In practice, such a storage assembly is often used as a hydrogen filling station for vehicles.

### BACKGROUND OF THE INVENTION

Known storage assemblies only have cylindrical pressure vessels storing pressurised fluid at the same pressure. Said pressure vessels are supported near or at their ends by a first support and a second support.

The need for reducing greenhouse gas emissions from transportation has made hydrogen fuelled vehicles increasingly popular, wherein an increasing number of solutions for freight and passenger vehicles is being developed and deployed. Such vehicles typically operate hydrogen tanks containing a maximum pressure of 35 MPa or 70 MPa. To accommodate these different pressures, filling stations are expected to supply hydrogen at these two different pressure levels. A hydrogen filling station is therefore an example of a gas storage location where storage of hydrogen at different pressures is required.

In situations wherein it is preferred to store pressurised fluid at different pressures, one storage assembly is built for one type of cylindrical pressure vessel to store the fluid at a first pressure and another storage assembly is built for another type of cylindrical pressure vessel to store the fluid at a higher second pressure.

Building two separate storage assemblies has amongst others the drawback that it is very labour intensive.

In addition, building two separate storage assemblies tends to require a relatively large ground storage area. Operators need to be able to operate and/or monitor each storage assembly from all sides. As such, the separate storage assemblies are generally not placed directly next to each other, and a relatively large gap is present between the two storage assemblies. In the present invention such a gap is not necessary. Accordingly, a smaller ground area is required for the storage assembly according to the invention.

The invention is based on the insight that there is a need to store pressurised fluids at a different pressure in a more efficient manner.

The invention is based on the insight that there is a need in the field of the art for storing pressurised fluid, such as hydrogen, at different pressures. In addition, the invention is based on the insight that it is preferred to store pressurised fluid at different pressures in a more efficient manner. It was recognised that storing pressurised fluid at different pressures should preferably not require a too large ground storage area and should preferable not be to too labour intensive.

### SUMMARY OF THE INVENTION

The invention has the objective to provide an improved, or at least alternative, storage assembly for storing pressurised fluid, such as hydrogen. This objective is reached by a storage assembly for storing pressurised fluid, such as hydrogen, which storage assembly comprises:
at least one cylindrical primary pressure vessel configured to store pressurised fluid at a first pressure and comprising a first primary end and an opposite second primary end and having a first longitudinal length,
at least one cylindrical secondary pressure vessel configured to store pressurised fluid at a second pressure being higher than the first pressure and comprising a first secondary end and an opposite second secondary end and having a second longitudinal length being smaller than the first longitudinal length,
a primary support supporting the at least one primary pressure vessel near or at the first primary end,
a secondary support supporting the at least one secondary pressure vessel near or at the first secondary end, and
a shared support supporting the at least one primary pressure vessel near or at the second primary end and supporting the at least one secondary pressure vessel near or at the second secondary end.

The storage assembly according to the invention allows to store pressurised fluids at different pressures. Said storage assembly uses three supports to store fluid at different pressures in pressure vessels. This is at least one support less when compared with the known situation having two separate storage assemblies.

Since it is labour intensive to build a support, the storage assembly according to the invention can be build more efficiently when compared with the known solution of two separate storage assemblies.

It is important to keep in mind that supports of a storage assembly having cylindrical pressure vessels to store an inflammable fluid, such as hydrogen, tend to be placed on a solid foundation due to safety regulations. Providing the foundations makes the construction of a support even more labour intensive. The storage assembly according the invention requires a foundation for three supports instead of for four supports.

In addition, it is preferred to use the ground area required to store pressurised fluid at different pressures in an efficient manner. With the storage assembly according to the invention is not required to build two separate storage assemblies. As a result, less ground area tends to be required to store fluid at different pressures. The fact that in the storage assembly according to the invention one of the supports is shared, tends to even further reduce the required ground area.

Furthermore, pressure vessels configured to store gas at a higher pressure tend to have a heavier construction than pressure vessels configured to store gas at a lower pressure. The fact that the secondary pressure vessel is configured to store gas at a higher pressure and has a second longitudinal length being smaller than the first longitudinal length facilitates the construction of the storage assembly because the total weight difference between the primary pressure vessel and the secondary pressure vessel is reduced. This also allows that less heavier building equipment can be used during the construction of the storage assembly. In addition, this facilities the production of the primary pressure vessel and the secondary pressure vessel at a single production facility and with the same production equipment.

In an embodiment of the storage assembly according to the invention, the storage assembly is a stationary storage assembly configured for storing the pressurised fluid at an absolute location. This way, the pressurised fluid is stored at a fixed location on Earth. The storage assembly is free from transportation means. More specifically, the storage assembly is free from transportation means for transporting the complete storage assembly to a different location.

In an embodiment of the storage assembly according to the invention, the second pressure is between, and including, 1.5 and 3 times higher than the first pressure.

In an embodiment of the storage assembly according to the invention, the first pressure is between, and including, 200 and 600 bar, and the second pressure is between, and including, 550 and 1200 bar.

In an embodiment of the storage assembly according to the invention, the primary pressure vessel has a primary mass [kg], the secondary pressure vessel has a secondary mass [kg], and the secondary mass is between, and including, 0.5 and 1.5 times the primary mass.

In an embodiment of the storage assembly according to the invention, the primary mass of the primary pressure vessel is between, and including, 3000 and 6000 kg, and the secondary mass of the secondary pressure vessel is between, and including, 2000 and 5000 kg.

In an embodiment of the storage assembly according to the invention, the primary pressure vessel has a primary linear mass density [kg/m] measured along the first longitudinal length, the secondary pressure vessel has a secondary linear mass density [kg/m] measured along the second longitudinal length, and the secondary linear mass density is larger than the primary linear mass density.

In an embodiment of the storage assembly according to the invention, the primary linear mass density of the primary pressure vessel is between, and including, 200 and 500 kg/m, and the secondary linear mass density of the secondary pressure vessel is between, and including, 250 and 550 kg/m.

In an embodiment of the storage assembly according to the invention, the secondary linear mass density is between, and including, 5 and 30% larger than the primary linear mass density.

In an embodiment of the storage assembly according to the invention, the second longitudinal length is between, and including, 10 and 50% smaller than the first longitudinal length.

In an embodiment of the storage assembly according to the invention, the primary pressure vessel comprises a primary vessel wall defining a primary inner diameter and having a primary wall thickness, and the secondary pressure vessel comprises a secondary vessel wall defining a secondary inner diameter and having a secondary wall thickness.

In an embodiment of the storage assembly according to the invention, a secondary ratio defined by the secondary wall thickness divided by the secondary inner diameter is larger than a primary ratio defined by the primary wall thickness divided by the primary inner diameter. The secondary ratio being larger than the first ratio facilitates the storing of fluid at the higher second pressure by the secondary pressure vessel when compared with the first pressure of the primary pressure vessel.

In an embodiment of the storage assembly according to the invention, the secondary ratio is between, and including, 1.5 and 3 times larger than the primary ratio.

In an embodiment of the storage assembly according to the invention, the secondary wall thickness is larger than the primary wall thickness.

In an embodiment of the storage assembly according to the invention, the secondary wall thickness is between, and including, 1.2 and 2.5 times the primary wall thickness.

In an embodiment of the storage assembly according to the invention, the primary wall thickness is between, and including, 15 and 50 mm, and the secondary wall thickness is between, and including, 25 and 70 mm.

In an embodiment of the storage assembly according to the invention, the secondary inner diameter is equal to or smaller than the primary inner diameter.

In an embodiment of the storage assembly according to the invention, the secondary inner diameter is between, and including, 0.5 and 0.95 times the primary outer diameter.

In an embodiment of the storage assembly according to the invention, the primary inner diameter is between, and including, 400 and 700 mm, and the secondary inner diameter is between, and including, 300 and 600 mm.

In an embodiment of the storage assembly according to the invention, the first primary end and the second primary end are inseparably connected, preferably integrally formed, with a primary vessel wall of the primary pressure vessel, and the first secondary end and the second secondary end are inseparably connected, preferably integrally formed, with a secondary vessel wall of the secondary pressure vessel.

In an embodiment of the storage assembly according to the invention, the first primary end is a domed first primary end, the second primary end is a domed second primary end, the first secondary end is a domed first secondary end, and the second secondary end is a domed second secondary end.

In an embodiment of the storage assembly according to the invention, the at least one primary pressure vessel and the at least one secondary pressure vessel extend in a same direction away from the shared support. This configuration allows a reduction of used ground area for the storage assembly and a reduction of the length of a surrounding safety fence.

In an embodiment of the storage assembly according to the invention, the primary support is located at a primary distance from the shared support, the secondary support is located at a secondary distance from the shared support, and the secondary distance is smaller than the primary distance.

In an embodiment of the storage assembly according to the invention, at least one primary pressure vessel is positioned above at least one secondary pressure vessel, and the secondary support is located within a footprint area defined by the shared support and the primary support. This allows that an even smaller ground area is used. In an embodiment of the storage assembly according to the invention, the storage assembly comprises a first lateral side and a second lateral side and the at least one secondary pressure vessel is located at the first lateral side and/or the second lateral side.

In an embodiment of the storage assembly according to the invention, the storage assembly comprises multiple secondary pressure vessels which are positioned on top of each other.

In an embodiment of the storage assembly according to the invention, said multiple secondary pressure vessels being positioned on top of each other are located at the first lateral side and/or the second lateral side of the assembly.

In an embodiment of the storage assembly according to the invention, none of the at least one primary pressure vessel is positioned below the least one secondary pressure vessel. This configuration allows that a relatively simply constructed secondary support may be used.

In an embodiment of the storage assembly according to the invention, the storage assembly comprises multiple primary pressure vessels.

In an embodiment of the storage assembly according to the invention, the primary support, the secondary support, and the shared support are configured to in use extend upwards from a ground surface and to hold each of the at least one primary pressure vessel and each of the at least one secondary pressure vessel at a distance from the ground surface. This does not necessarily mean that the primary and secondary pressure vessels are located at a same distance from the ground surface. The distance between the ground surface and the primary and secondary pressure vessels may differ.

In an embodiment of the storage assembly according to the invention, each of the at least one primary pressure vessel and each of the at least one secondary pressure vessel is surrounded by air. This allows that the at least one primary pressure vessel and the at least one secondary pressure vessel are freely accessible, such as freely accessible for a person for inspection and/or maintenance.

In an embodiment of the storage assembly according to the invention, each of the at least one primary pressure vessel and each of the at least one secondary pressure vessel is freely accessible, such as freely accessible for a person.

In an embodiment of the storage assembly according to the invention, the primary support comprises a primary seismic bracing structure, the secondary support comprises a secondary seismic bracing structure, and the shared support comprises a shared seismic bracing structure.

In an embodiment of the storage assembly according to the invention, each of the at least one primary pressure vessel is supported near or at the first primary end by a first primary support unit and is supported near or at the second primary end by a second primary support unit, each of the at least one secondary pressure vessel is supported near or at the first secondary end by a first secondary support unit and is supported near or at the second secondary end by a second secondary support unit, said first primary support unit forms part of the primary support, said first secondary support unit forms part of the secondary support, said second primary support unit and said second secondary support unit form part of the shared support.

In an embodiment of the storage assembly according to the invention, the first primary support unit and the second primary support unit are releasably connected to the primary pressure vessel, and the first secondary support unit and the second secondary support unit are releasably connected to the secondary pressure vessel.

In an embodiment of the storage assembly according to the invention, the first primary support unit is a rectangular first primary support unit, preferably a square first primary support unit, the second primary support unit is a rectangular second primary support unit, preferably a square second primary support unit, the first secondary support unit is a rectangular first secondary support unit, preferably a square first secondary support unit, and the second secondary support unit is a rectangular second secondary support unit, preferably a square second secondary support unit.

In an embodiment of the storage assembly according to the invention, the storage assembly comprises multiple secondary pressure vessels, and the first secondary support units supporting the multiple secondary pressure vessels are interconnected and the second secondary support units supporting the multiple secondary pressure vessels are interconnected. The first secondary support units are preferably interconnected via bolted connections. The second secondary support units are preferably interconnected via bolted connections.

In an embodiment of the storage assembly according to the invention, the storage assembly comprises multiple primary pressure vessels, and the first primary support units supporting the multiple primary pressure vessels are interconnected and the second primary support units supporting the multiple primary pressure vessels are interconnected. The first primary support units are preferably interconnected via bolted connections. The second primary support units are preferably interconnected via bolted connections.

In an embodiment of the storage assembly according to the invention, the interconnected second secondary support units and the interconnected second primary support units are connected to each other, preferably via bolted connections.

In an embodiment of the storage assembly according to the invention, at least one of the first secondary support units comprises a first secondary hoisting member or is configured to be coupled to a removable first secondary hoisting member, at least one of the second secondary support units comprises a second secondary hoisting member or is configured to be coupled to a removable second secondary hoisting member, and the (removable) first secondary hoisting member and the (removable) second secondary hoisting member are configured to be attached to hoisting equipment and hoisted while the first secondary support unit and the second secondary support unit support the respective secondary pressure vessel.

In an embodiment of the storage assembly according to the invention, at least one the first primary support units comprises a first primary hoisting member or is configured to be coupled to a removable first primary hoisting member, at least one of the second primary support units is provided with a secondary primary hoisting member or is configured to be coupled to a removable second primary hoisting member, and the (removable) first primary hoisting member and the (removable) second primary hoisting member are configured to be attached to hoisting equipment and hoisted while the first primary support unit and the second primary support unit support the respective primary pressure vessel.

In an embodiment of the storage assembly according to the invention, the storage assembly comprises the features of any combination of any number of the above defined embodiments of the storage assembly according to the invention.

In an embodiment of the storage assembly according to the invention, the storage assembly comprises pressurised fluid, such as hydrogen, stored at the first pressure in the at least one cylindrical primary pressure vessel and pressurised fluid, such as hydrogen, stored at the second pressure in the at least one cylindrical secondary pressure vessel.

The invention further relates to a method for producing a storage assembly according to the invention, wherein said method comprises providing the primary support supporting the at least one primary pressure vessel near or at the first primary end, providing the secondary support supporting the at least one secondary pressure vessel near or at the first secondary end, and providing the shared support supporting the at least one primary pressure vessel near or at the second primary end and supporting the at least one secondary pressure vessel near or at the second secondary end.

In an embodiment of the method according to the invention, said method comprises for each of the at least one primary pressure vessel providing the first primary support unit supporting said primary pressure vessel to construct the primary support, for each of the at least one secondary pressure vessel providing the first secondary support unit supporting said secondary pressure vessel to construct the secondary support, and for each of the at least one primary pressure vessel providing the second primary support unit of said primary pressure vessel and for each of the at least one secondary pressure vessel providing the second secondary support unit of said secondary pressure vessel to construct the shared support.

In an embodiment of the method according to the invention, said method comprises pre-assembling a secondary module by interconnecting the first secondary support units supporting at least part of the multiple secondary pressure vessels and by interconnecting the second secondary support units supporting said at least part of the multiple secondary pressure vessels, and providing the secondary module to construct the secondary support with the interconnected first secondary support units and to construct the shared support with the interconnected second secondary support units.

In an embodiment of the method according to the invention, said method comprises providing a secondary module formed by interconnected first secondary support units supporting at least part of the multiple secondary pressure vessels and by interconnected second secondary support units supporting said at least part of the multiple secondary pressure vessels to construct the secondary support with the interconnected first secondary support units and to construct the shared support with the interconnected second secondary support units.

In an embodiment of the method according to the invention, said method comprises pre-assembling a primary module by interconnecting the first primary support units supporting at least part of the multiple primary pressure vessels and by interconnecting the second primary support units supporting said at least part of the multiple primary pressure vessels, and providing the primary module to construct the primary support with the interconnected first primary support units and to construct the shared support with the interconnected second primary support units.

In an embodiment of the method according to the invention, said method comprises providing a primary module formed by interconnected first primary support units supporting at least part of the multiple primary pressure vessels and by interconnected second primary support units supporting said at least part of the multiple primary pressure vessels to construct the primary support with the interconnected first primary support units and to construct the shared support with the interconnected second primary support units.

In an embodiment of the method according to the invention, said method comprises hoisting one of the secondary pressure vessels being supported by the first secondary support unit provided with the (removable) first secondary hoisting member and by the second secondary support unit provided with the (removable) second secondary hoisting member with hoisting equipment attached to said (removable) first secondary hoisting member and said (removable) second secondary hoisting member in order to construct the secondary support and the shared support.

In an embodiment of the method according to the invention, said method comprises hoisting one of the primary pressure vessels being supported by the first primary support unit provided with the (removable) first primary hoisting member and by the second primary support unit provided with the (removable) second primary hoisting member with hoisting equipment attached to said (removable) first primary hoisting member and said (removable) second primary hoisting member in order to construct the primary support and the shared support.

In an embodiment of the method according to the invention, one of the first secondary support units of the secondary module is provided with the (removable) first secondary hoisting member and one of the second secondary support units of the secondary module is provided with the (removable) second secondary hoisting member and said method comprises hoisting the secondary module with hoisting equipment attached to said (removable) first secondary hoisting member and said (removable) second secondary hoisting member in order to construct the secondary support and the shared support.

In an embodiment of the method according to the invention, one of the first primary support units of the primary module is provided with the (removable) first primary hoisting member and one of the second primary support units of the primary module is provided with the (removable) second primary hoisting member and said method comprises hoisting the primary module with hoisting equipment attached to said (removable) first primary hoisting member and said (removable) second primary hoisting member in order to construct the primary support and the shared support.

In an embodiment of the method according to the invention, said method comprises the features of any combination of any number of the above defined embodiments of the method according to the invention.

### BRIEF DESCRIPTION OF THE DRAWINGS

Embodiments of the storage assembly according to the invention and the method according to the invention will be described by way of example only, with reference to the accompanying schematic drawings in which corresponding reference symbols indicate corresponding parts, and in which:

the FIGS. 1A and 1B schematically show two views in perspective of an embodiment of the storage assembly according to the invention, the FIGS. 1C-F schematically show four side views of the storage assembly of the FIGS. 1A and 1B,

FIG. 1G schematically shows a top view of the storage assembly of the FIGS. 1A and 1B, wherein the arrows IC, ID, IE, IF indicate the direction of the side views of the FIG. 1C, 1D, 1E, 1F, respectively,

FIG. 2A schematically shows a side view of one of the primary pressure vessels of the storage assembly of the FIGS. 1A and 1B,

FIG. 2B schematically shows a cross sectional view along line IIB-IIB of FIG. 2A,

FIG. 2C schematically shows a side view of the primary pressure vessel of FIG. 2A supported by the first primary support unit and the second primary support unit,

FIG. 3A schematically shows a side view of one of the secondary pressure vessels of the storage assembly of the FIGS. 1A and 1B,

FIG. 3B schematically shows a cross sectional view along line IIIB-IIIB of FIG. 3A,

FIG. 3C schematically shows a side view of the secondary pressure vessel of FIG. 3A supported by the first secondary support unit and the second secondary support unit,

FIG. 4 schematically shows a view in perspective of a primary module for producing the storage assembly of the FIGS. 1A and 1B,

FIG. 5 schematically shows a view in perspective of a secondary module for producing the storage assembly of the FIGS. 1A and 1B,

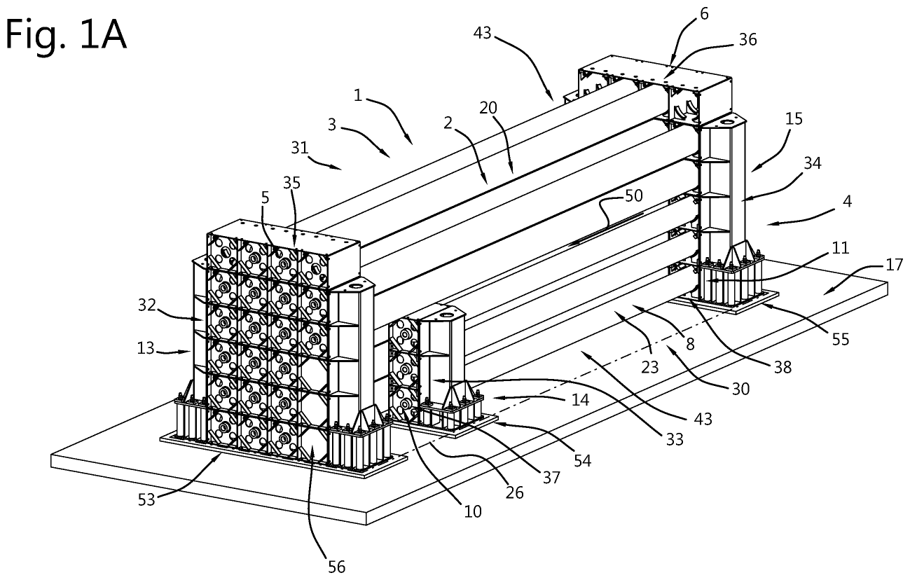

the FIGS. 6A-6F schematically show an embodiment of the method according to the invention to produce the storage assembly of the FIGS. 1A and 1B.

### DETAILED DESCRIPTION OF THE DRAWINGS

The 1A-G show views of an embodiment of the storage assembly 1 according to the invention. The storage assembly 1 configured to store pressurised fluid, such as hydrogen.

The storage assembly 1 comprises at least one cylindrical primary pressure vessel 2 configured to store pressurised fluid at a first pressure. Each primary pressure vessel 2 comprises a first primary end 5, an opposite second primary end 6 and a first longitudinal length 7. More specifically, the storage assembly 1 comprises multiple primary pressure vessels 2. Even more specifically, the storage assembly 1 comprises nineteen primary pressure vessels 2. The storage assembly 1 comprises pressurised fluid, such as hydrogen, stored at the first pressure in the at least one cylindrical primary pressure vessel 2.

The storage assembly 1 comprises at least one cylindrical secondary pressure vessel 8 configured to store pressurised fluid at a second pressure being higher than the first pressure. The storage assembly 1 comprises pressurised fluid, such as hydrogen, stored at the second pressure in the at least one cylindrical secondary pressure vessel 8. The second pressure is between, and including, 1.5 and 3 times higher than the first pressure. The first pressure may be between, and including, 200 and 600 bar, and the second pressure may be between, and including, 550 and 1200 bar.

Each secondary pressure vessel 8 comprises a first secondary end 10, an opposite second secondary end 11 and a second longitudinal length 12. The second longitudinal length 12 is smaller than the first longitudinal length 7. The second longitudinal length 12 is between, and including, 10 and 50% smaller than the first longitudinal length 7.

More specifically, the storage assembly 1 comprises multiple secondary pressure vessels 8. Even more specifically, the storage assembly 1 comprises three secondary pressure vessels 8.

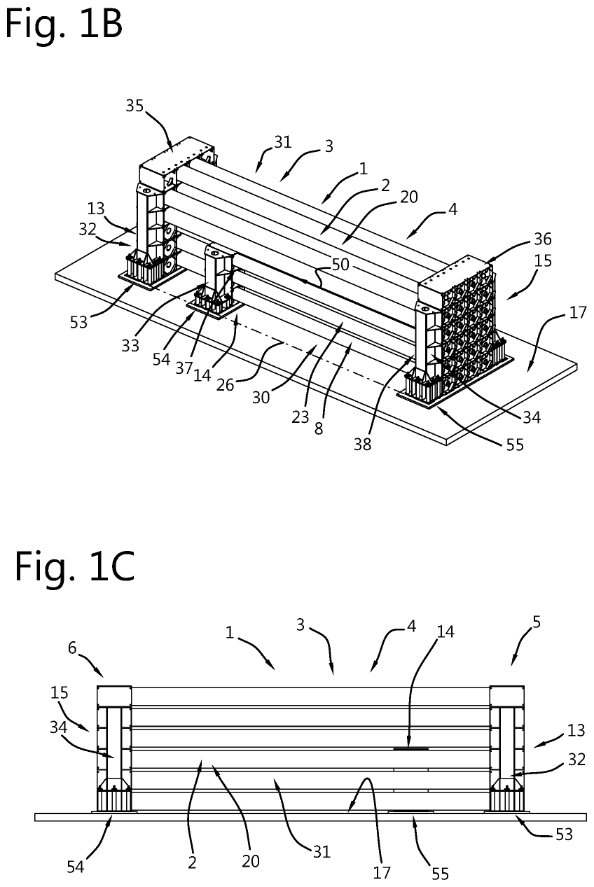

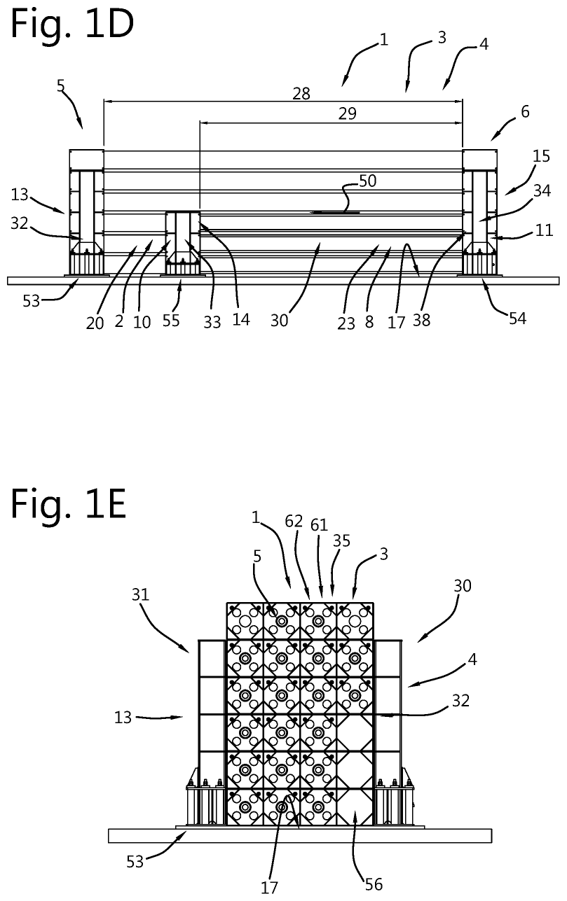

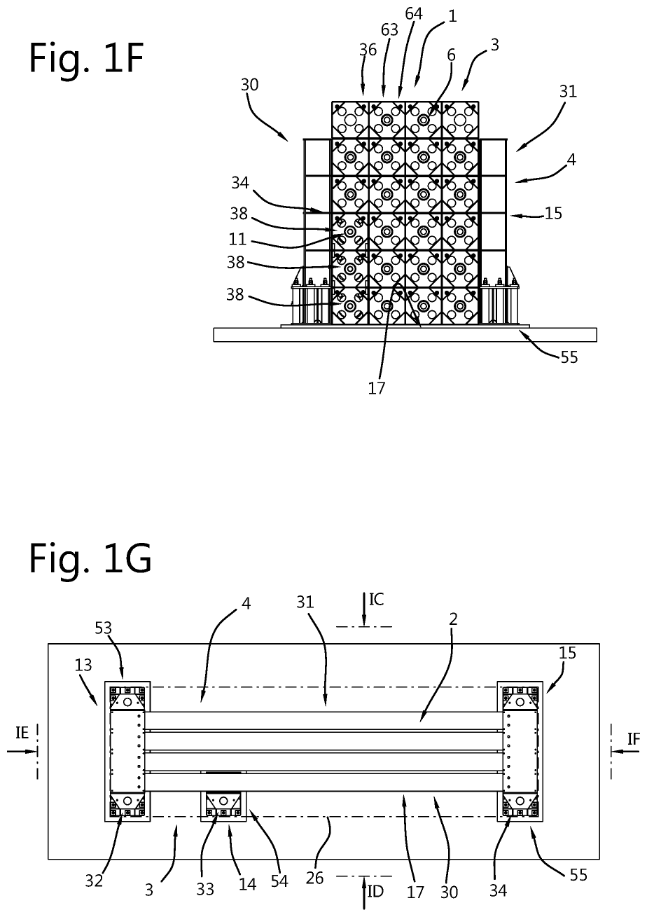

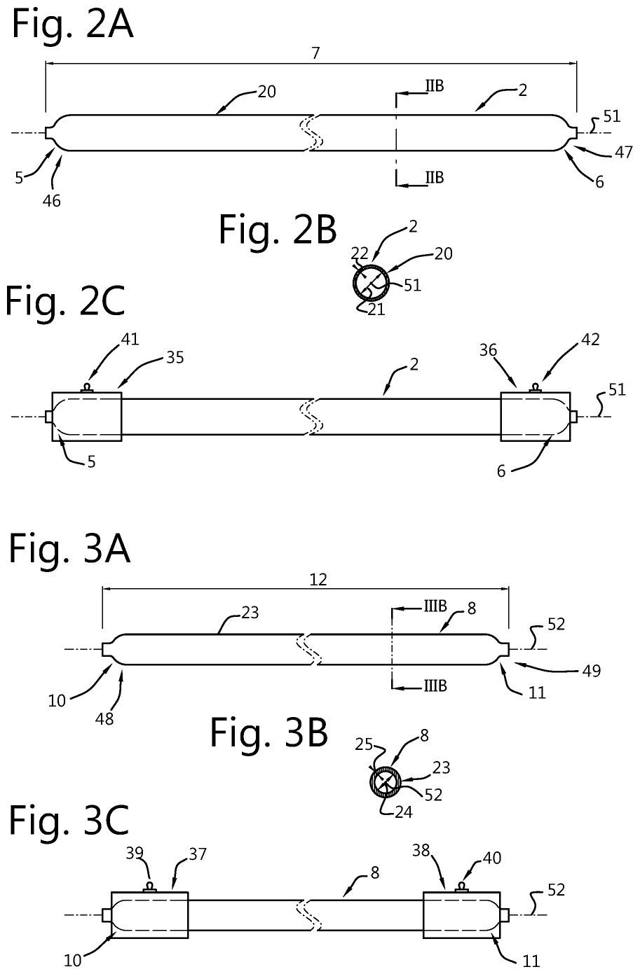

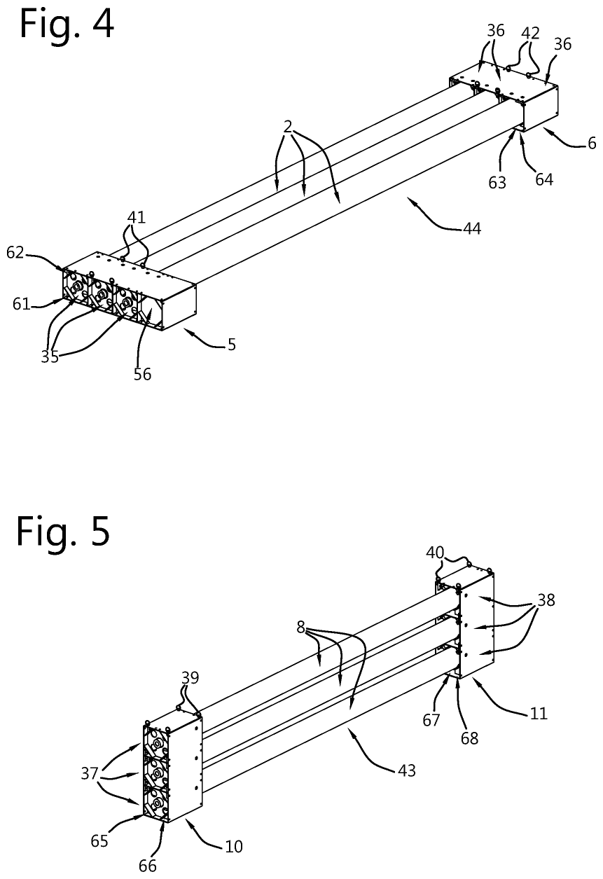

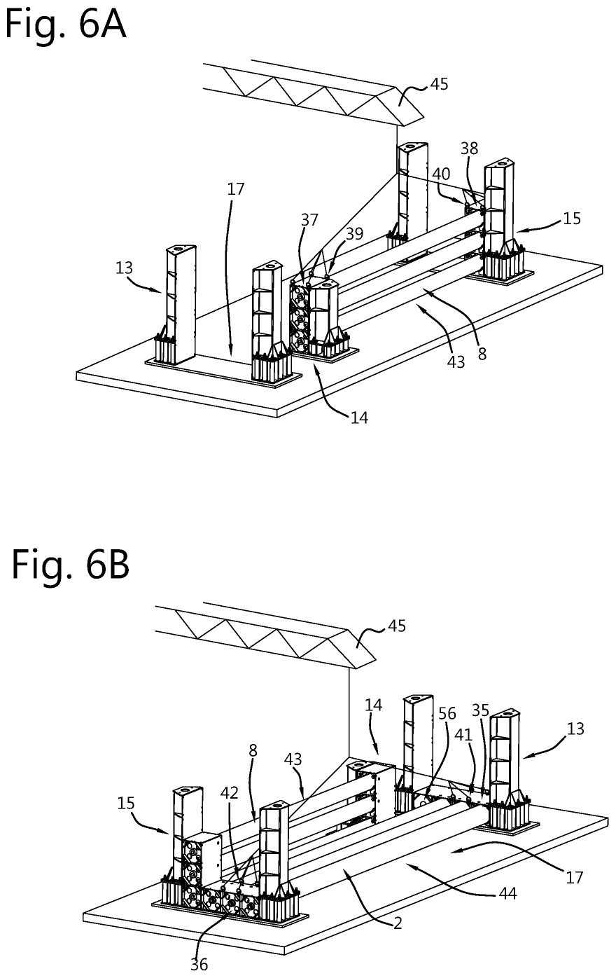

The first primary end 5 and the second primary end 6 are inseparably connected, preferably integrally formed, with a primary vessel wall 20 of the primary pressure vessel 2 (see also the FIGS. 2A-C). The first secondary end 10 and the second secondary end 11 are inseparably connected, preferably integrally formed, with a secondary vessel wall 23 of the secondary pressure vessel 8 (see also the FIGS. 3A-C).

The first primary end is a domed first primary end 46, the second primary end is a domed second primary end 47, the first secondary end is a domed first secondary end 48, and the second secondary end is a domed second secondary end 49.

The storage assembly 1 comprises a primary support 13 supporting the primary pressure vessels 2 near or at their first primary end 5. The storage assembly 1 comprises a secondary support 14 supporting the secondary pressure vessels 8 near or at their first secondary end 10. The storage assembly 1 comprises a shared support 15 supporting the primary pressure vessels 2 near or at their second primary end 6 and supporting the secondary pressure vessels 8 near or at their second secondary end 11.

The storage assembly 1 allows to store pressurised fluids at different pressures. Said storage assembly 1 uses three supports (more specifically the primary support 13, the secondary support 14, and shared support 15) to store fluid at different pressures in pressure vessels.

This is at least one support less when compared with the known situation having two separate storage assemblies.

Since it is labour intensive to build a support, the storage assembly 1 can be build more efficiently when compared with the known solution of two separate storage assemblies.

It is important to keep in mind that supports of a storage assembly 1 having cylindrical pressure vessels to store an inflammable fluid, such as hydrogen, tend to be placed on a solid foundation due to safety regulations. The primary support 13 is positioned on a primary foundation 53, the secondary support 14 is positioned on a secondary foundation 54, and the shared support 15 is positioned on a shared foundation 55. Providing the foundations makes the construction of a support even more labour intensive. The storage assembly 1 according the invention requires a foundation for three supports instead of for four supports.

In addition, it is preferred to use the ground area required to store pressurised fluid at different pressures in an efficient manner. With the storage assembly 1 according to the invention is not required to build two separate storage assemblies. As a result, less ground area tends to be required to store fluid at different pressures. The fact that in the storage assembly 1 according to the invention one of the supports is shared, tends to even further reduce the required ground area.

Furthermore, pressure vessels configured to store gas at a higher pressure tend to have a heavier construction than pressure vessels configured to store gas at a lower pressure. The fact that the secondary pressure vessel 8 is configured to store gas at a higher pressure and has a second longitudinal length 12 being smaller than the first longitudinal length 7 facilitates the construction of the storage assembly 1 because the total weight difference between the primary pressure vessel 2 and the secondary pressure vessel 8 is reduced. This also allows that less heavier building equipment can be used during the construction of the storage assembly 1. In addition, this facilities the production of the primary pressure vessel 2 and the secondary pressure vessel 8 at a single production facility and with the same production equipment.

The storage assembly 1 is a stationary storage assembly 3 configured for storing the pressurised fluid at an absolute location 4. This way, the pressurised fluid is stored at a fixed location on Earth. The storage assembly 1 is free from transportation means. More specifically, the storage assembly 1 is free from transportation means for transporting the complete storage assembly to a different location on Earth. The technical field of transportable storage assemblies has to deal with other technical considerations and challenges than the technical field of stationary storage assemblies 3.

FIG. 2A shows a side view of one of the primary pressure vessels 2 of the storage assembly 1 of the FIGS. 1A and 1B. FIG. 2B shows a cross sectional view along line II-Il of FIG. 2A. FIG. 2C shows a side view of the primary pressure vessel 2 of FIG. 2A supported by the first primary support unit 35 and second primary support unit 36. The primary pressure vessel 2 extends along a primary longitudinal axis 51.

FIG. 3A shows a side view of one of the secondary pressure vessels 8 of the storage assembly 1 of the FIGS. 1A and 1B. FIG. 3B shows a cross sectional view along line III-III of FIG. 3A. FIG. 3C shows a side view of the secondary pressure vessel 8 of FIG. 3A supported by the first secondary support unit 37 and second secondary support unit 38. The secondary pressure vessel 8 extends along a secondary longitudinal axis 52.

The primary pressure vessel 2 has a primary mass [kg], the secondary pressure vessel 8 has a secondary mass [kg], and the secondary mass is between, and including, 0.5 and 1.5 times the primary mass. The primary mass of the primary pressure vessel 2 may be between, and including, 3000 and 6000 kg, and the secondary mass of the secondary pressure vessel 8 may be between, and including, 2000 and 5000 kg.

The primary pressure vessel 2 has a primary linear mass density [kg/m] measured along the first longitudinal length 7, the secondary pressure vessel 8 has a secondary linear mass density [kg/m] measured along the second longitudinal length 12, and the secondary linear mass density is larger than the primary linear mass density. The secondary linear mass density is between, and including, 5 and 30% larger than the primary linear mass density. The primary linear mass density of the primary pressure vessel may be between, and including, 200 and 500 kg/m, and the secondary linear mass density of the secondary pressure vessel may be between, and including, 250 and 550 kg/m.

The primary pressure vessel 2 comprises a primary vessel wall 20 defining a primary inner diameter 21 and having a primary wall thickness 22. The secondary pressure vessel 8 comprises a secondary vessel wall 23 defining a secondary inner diameter 24 and having a secondary wall thickness 25. A secondary ratio defined by the secondary wall thickness 25 divided by the secondary inner diameter 24 is larger than a primary ratio defined by the primary wall thickness 22 divided by the primary inner diameter 21. The secondary ratio being larger than the first ratio facilitates the storing of fluid at the higher second pressure by the secondary pressure vessel 8 when compared with the first pressure of the primary pressure vessel 2. The secondary ratio is between, and including, 1.5 and 3 times larger than the primary ratio.

The secondary wall thickness 25 is larger than the primary wall thickness 22. The secondary wall thickness 25 is between, and including, 1.2 and 2.5 times the primary wall thickness 22. The primary wall thickness 22 is between, and including, 15 and 50 mm, and the secondary wall thickness 25 is between, and including, 25 and 70 mm.

The secondary inner diameter 24 is equal to or smaller than the primary inner diameter 21. The secondary inner diameter 24 is between, and including, 0.5 and 0.95 times the primary outer diameter. The primary inner diameter 21 is between, and including, 400 and 700 mm, and the secondary inner diameter 24 is between, and including, 300 and 600 mm.

Returning to the FIGS. 1A-G, the primary pressure vessels 2 and the secondary pressure vessels 8 extend in a same direction 50 away from the shared support 15. This preferred configuration allows reduction of the used ground area and reduction of the length of a surrounding safety fence.

The primary support 13 is located at a primary distance 28 from the shared support 15, the secondary support 14 is located at a secondary distance 29 from the shared support 15, and the secondary distance 29 is smaller than the primary distance 28.

At least one primary pressure vessel 2 is positioned above at least one secondary pressure vessel 8. More specifically, two primary pressure vessel 2 are positioned above three secondary pressure vessels 8.

The secondary support 14 is located within a footprint area 26 defined by the shared support 15 and the primary support 13. This way an even smaller ground area is used.

The storage assembly 1 comprises a first lateral side 30 and a second lateral side 31 and the secondary pressure vessels 8 are located at the first lateral side 30. In another example of the storage assembly 1 (not shown), the secondary pressure vessels 8 are located at the second lateral side 31. It is also possible that the secondary pressure vessels 8 are located at the first lateral side 30 and the second lateral side 31.

The secondary pressure vessels 8 are positioned on top of each other. The secondary pressure vessels 8 being positioned on top of each other may be located at the first lateral side 30 and/or the second lateral side 31 of the assembly.

None of the primary pressure vessels 2 is positioned below the least one secondary pressure vessel 8. This configuration allows that a relatively simply constructed secondary support 14 may be used.

The primary support 13, the secondary support 14, and the shared support 15 are configured to in use extend upwards from a ground surface 17 and to hold each of the at least one primary pressure vessel 2 and each of the at least one secondary pressure vessel 8 at a distance from the ground surface 17. This does not necessarily mean that the primary and secondary pressure vessels 2 and 8 are located at a same distance from the ground surface 17. The distance between the ground surface 17 and the primary and secondary pressure vessels 2 and 8 may differ.

Each of the at least one primary pressure vessel 2 and each of the at least one secondary pressure vessel 8 is surrounded by air. This allows that the at least one primary pressure vessel 2 and the at least one secondary pressure vessel 8 are freely accessible, such as freely accessible for a person for inspection and/or maintenance.

The primary support 13 comprises a primary seismic bracing structure 32, the secondary support 14 comprises a secondary seismic bracing structure 33, and the shared support 15 comprises a shared seismic bracing structure 34.

Each of the primary pressure vessels 2 is supported near or at the first primary end 5 by a first primary support unit 35 and is supported near or at the second primary end 6 by a second primary support unit 36. Each of the secondary pressure vessels 8 is supported near or at the first secondary end 10 by a first secondary support 14 and is supported near or at the second secondary end 11 by a second secondary support unit 38. The first primary support units 35 form part of the primary support 13. The first secondary support units 37 form part of the secondary support 14. The second primary support units 36 and said second secondary support units 38 form part of the shared support 15.

The first primary support unit 35 and the second primary support unit 36 are releasably connected to the primary pressure vessel 2. The first secondary support unit 37 and the second secondary support unit 38 are releasably connected to the secondary pressure vessel 8.

The first primary support unit 35 is a rectangular first primary support unit 61, preferably a square first primary support unit 62. The second primary support unit 36 is a rectangular second primary support unit 63, preferably a square second primary support unit 64. The first secondary support unit 37 is a rectangular first secondary support unit 65, preferably a square first secondary support unit 66. The second secondary support unit 38 is a rectangular second secondary support unit 67, preferably a square second secondary support unit 68.

The first secondary support units 37 supporting the multiple secondary pressure vessels 8 are interconnected and the second secondary support units 38 supporting the multiple secondary pressure vessels 8 are interconnected. The first secondary support units 37 are interconnected via bolted connections. The second secondary support units 38 are interconnected via bolted connections.

The first primary support units 35 supporting the multiple primary pressure vessels 2 are interconnected and the second primary support units 36 supporting the multiple primary pressure vessels 2 are interconnected. The first primary support units 35 are interconnected via bolted connections. The second primary support units 36 are interconnected via bolted connections.

The interconnected second secondary support units 38 and the interconnected second primary support units 36 are connected to each other via bolted connections.

It will be clear to the skilled person that other connection techniques than bolted connections may be used to establish a (inter) connection between the above identified support units, such as welding.

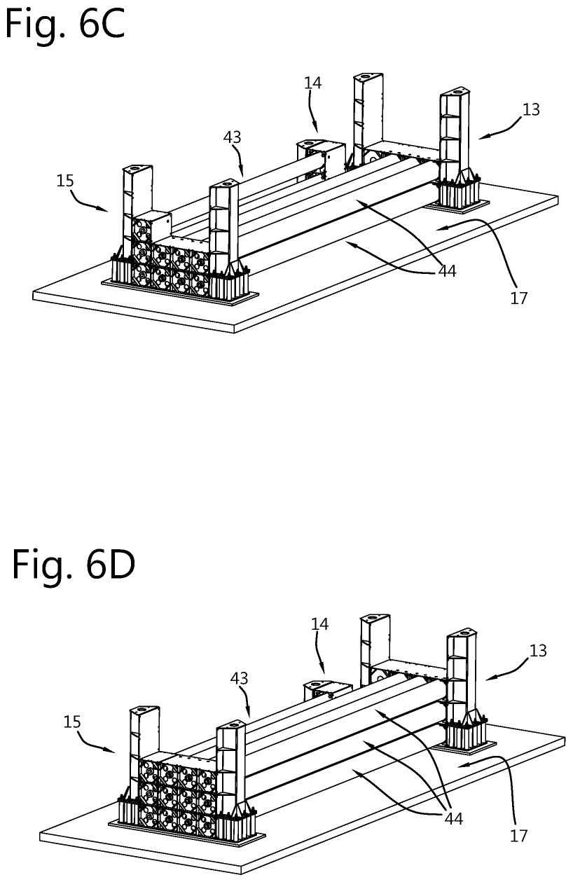

FIG. 4 shows an embodiment of a primary module 44 for producing the storage assembly 1 of the FIGS. 1A and 1B. The primary module 44 is pre-assembled by interconnecting the first primary support units 35 supporting part of the multiple primary pressure vessels 2 and by interconnecting the second primary support units 36 supporting said part of the multiple primary pressure vessels 2. Said pre-assembling of the primary module 44 may be performed at a different location, such as a production facility. The primary module 44 is subsequently used to construct the primary support 13 with the interconnected first primary support units 35 and to construct the shared support 15 with the interconnected second primary support units 36. Multiple primary modules 44 are used to construct the primary support 13 and the shared support 15 of the storage assembly 1 of the FIGS. 1A and 1B.

In an alternative embodiment of the method, a secondary module 43 is provided which secondary module 43 is formed by interconnected first secondary support units 37 supporting at least part of the multiple secondary pressure vessels 8 and by interconnected second secondary support units 38 supporting said at least part of the multiple secondary pressure vessels 8 to construct the secondary support 14 with the interconnected first secondary support units 37 and to construct the shared support 15 with the interconnected second secondary support units 38.

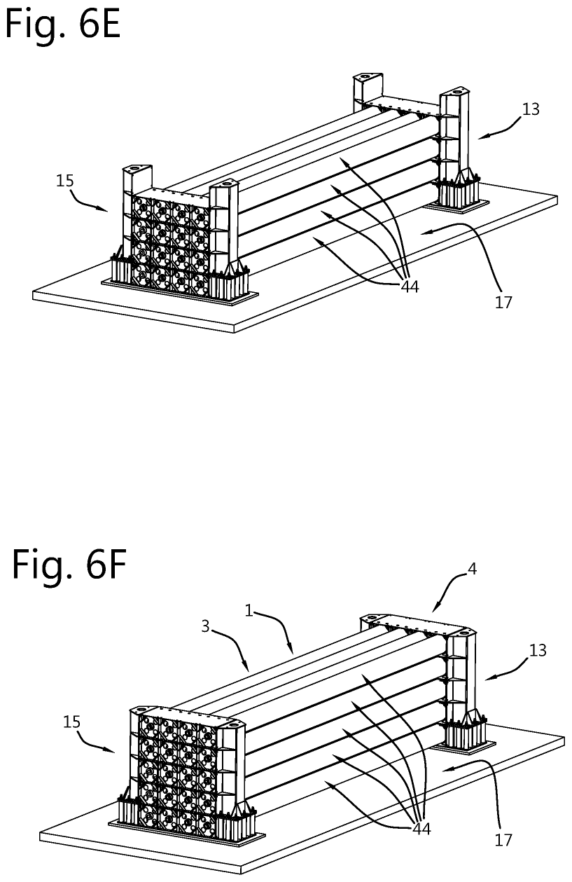

FIG. 5 shows an embodiment of a secondary module 43 for producing the storage assembly 1 of the FIGS. 1A and 1B. The secondary module 43 is pre-assembled by interconnecting the first secondary support units 37 supporting the multiple secondary pressure vessels 8 and by interconnecting the second secondary support units 38 supporting said multiple secondary pressure vessels 8. Said pre-assembling of the primary module 43 may be performed at a different location, such as a production facility. The secondary module 43 is subsequently used to construct the secondary support 14 with the interconnected first secondary support units 37 and to construct the shared support 15 with the interconnected second secondary support units 38. Only one secondary module 43 is used to construct the secondary support 14 and the shared support 15 of the storage assembly 1 of the FIGS. 1A and 1B.

In an alternative embodiment of the method, a primary module 44 is provided which primary module 44 is formed by interconnected first primary support units 35 supporting at least part of the multiple primary pressure vessels 2 and by interconnected second primary support units 36 supporting said at least part of the multiple primary pressure vessels 2 to construct the primary support 13 with the interconnected first primary support units 35 and to construct the shared support 15 with the interconnected second primary support units 38.

It will be clear to the skilled person that the storage assembly 1 of the FIGS. 1A and 1B may also be constructed with multiple single primary pressure vessels 2 supported by the first primary support unit 35 and the second primary support unit 36 as shown in FIG. 2C and multiple single secondary pressure vessels 8 supported by the first secondary support unit 37 and the second secondary support unit 38 as shown in FIG. 3C.

At least one the first primary support units 35 is configured to be coupled to a removable first primary hoisting member 41 and at least one of the second primary support units 36 is configured to be coupled to a removable second primary hoisting member 42 (see figures the 2C and 4). The removable first primary hoisting member 41 and the removable second primary hoisting member 42 have been removed once the construction of the storage assembly 1 is finalised. The removable first primary hoisting member 41 and the removable second primary hoisting member 42 are configured to be attached to hoisting equipment 45 and hoisted while the first primary support unit 35 and the second primary support unit 36 support the respective primary pressure vessel 2.

In another example of the storage assembly 1 according to the invention (not shown), at least one the first primary support units 35 comprises a first primary hoisting member 41, and at least one of the second primary support units 36 is provided with a secondary primary hoisting member. The first primary hoisting member 41 and the second primary hoisting member 42 remain after the construction of the storage assembly 1 has been finalised.

At least one of the first secondary support units 37 is configured to be coupled to a removable first secondary hoisting member 39 and at least one of the second secondary support units 38 is configured to be coupled to a removable second secondary hoisting member 40 (see the FIGS. 3C and 5). The removable first secondary hoisting member 39 and the removable second secondary hoisting member 40 have been removed once the construction of the storage assembly 1 is finalised. The removable first secondary hoisting member 39 and the removable second secondary hoisting member 40 are configured to be attached to hoisting equipment 45 and hoisted while the first secondary support unit 37 and the second secondary support unit 38 support the respective secondary pressure vessel 8.

In another example of the storage assembly 1 according to the invention (not shown), a least one of the first secondary support units 37 comprises a first secondary hoisting member 39, and at least one of the second secondary support units 38 comprises a second secondary hoisting member 40. The first secondary hoisting member 39 and the second secondary hoisting member 40 remain after the construction of the storage assembly 1 has been finalised.

The FIGS. 6A-6F show an embodiment of the method according to the invention to produce the storage assembly 1 of the FIGS. 1A and 1B. The method comprises providing the primary support 13 supporting the at least one primary pressure vessel 2 near or at the first primary end 5, providing the secondary support 14 supporting the at least one secondary pressure vessel 8 near or at the first secondary end 10, and providing the shared support 15 supporting the at least one primary pressure vessel 2 near or at the second primary end 6 and supporting the at least one secondary pressure vessel 8 near or at the second secondary end 11.

The method comprises for each of the at least one primary pressure vessel 2 providing the first primary support unit 35 supporting said primary pressure vessel 2 to construct the primary support 13, for each of the at least one secondary pressure vessel 8 providing the first secondary support unit 37 supporting said secondary pressure vessel 8 to construct the secondary support 14, and for each of the at least one primary pressure vessel 2 providing the second primary support unit 36 of said primary pressure vessel 2 and for each of the at least one secondary pressure vessel 8 providing the second secondary support unit 38 of said secondary pressure vessel 8 to construct the shared support 15.

The method comprises pre-assembling a primary module 44 by interconnecting the first primary support units 35 supporting at least part of the multiple primary pressure vessels 2 and by interconnecting the second primary support units 36 supporting said at least part of the multiple primary pressure vessels 2, and providing the primary module 44 to construct the primary support 13 with the interconnected first primary support units 35 and to construct the shared support 15 with the interconnected second primary support units 36. FIG. 4 shows an embodiment of a primary module 44 for constructing the storage assembly 1 of the FIGS. 1A and 1B.

The method comprises pre-assembling a secondary module 43 by interconnecting the first secondary support 14s units supporting at least part of the multiple secondary pressure vessels 8 and by interconnecting the second secondary support 14s units supporting said at least part of the multiple secondary pressure vessels 8, and providing the secondary module 43 to construct the secondary support 14 with the interconnected first secondary support 14s units and to construct the shared support 15 with the interconnected second secondary support units 38. FIG. 5 shows an embodiment of a secondary module 43 for constructing the storage assembly 1 of the FIGS. 1A and 1B.

The method comprises hoisting one of the primary pressure vessels 2 being supported by the first primary support unit 35 provided with the (removable) first primary hoisting member 41 and by the second primary support unit 36 provided with the (removable) second primary hoisting member 42 with hoisting equipment 45 attached to said (removable) first primary hoisting member 41 and said (removable) second primary hoisting member 42 in order to construct the primary support 13 and the shared support 15.

The method comprises hoisting one of the secondary pressure vessels 8 being supported by the first secondary support unit 37 provided with the (removable) first secondary hoisting member 39 and by the (removable) second secondary support unit 38 provided with the second secondary hoisting member 40 with hoisting equipment 45 attached to said (removable) first secondary hoisting member 39 and said (removable) second secondary hoisting member 40 in order to construct the secondary support 14 and the shared support 15.

One of the first primary support units 35 of the primary module 44 is provided with the (removable) first primary hoisting member 41 and one of the second primary support units 36 of the primary module 44 is provided with the (removable) second primary hoisting member 42 and said method comprises hoisting the primary module 44 with hoisting equipment 45 attached to said (removable) first primary hoisting member 41 and said (removable) second primary hoisting member 42 in order to construct the primary support 13 and the shared support 15.

One of the first secondary support units 37 of the secondary module 43 is provided with the (removable) first secondary hoisting member 39 and one of the second secondary support units 38 of the secondary module 43 is provided with the (removable) second secondary hoisting member 40 and said method comprises hoisting the secondary module 43 with hoisting equipment 45 attached to said (removable) first secondary hoisting member 39 and said (removable) second secondary hoisting member 40 in order to construct the secondary support 14 and the shared support 15.

In FIG. 6A, two primary seismic bracing structure 32s are provided on a primary foundation, one secondary seismic bracing structure 33 is provided on a secondary foundation 54, and two shared seismic bracing structures 34 are provided on a shared foundation 55. The secondary module 43 of FIG. 5 is hoisted by hoisting equipment 45 to place the secondary module 43 in position for the construction of the secondary support 14 and the shared support 15. The hoisting equipment 45 is detached from the removable first secondary hoisting members 39 and the removable second secondary hoisting members 40 after the secondary module 43 is placed in position. The first secondary hoisting members 39 and the second secondary hoisting members 40 are subsequently removed. The interconnected first secondary support units 37 are connected to the secondary seismic bracing structure 33 via bolted connections. The interconnected second secondary support units 38 are connected to one of the shared seismic bracing structures 34 via bolted connections.

In FIG. 6B, the primary module 44 of FIG. 4 is hoisted by the same hoisting equipment 45 to place the primary module 44 in position for the construction of the primary support 13 and the shared support 15. The hoisting equipment 45 is detached from the removable first primary hoisting members 41 and the removable second primary hoisting members 42 after the primary module 44 is placed in position. The first primary hoisting members 41 and the second primary hoisting members 42 are subsequently removed. The interconnected first primary support units 35 are connected to both the primary seismic bracing structures 32 via bolted connections. In order to facilitate the connection with both the primary seismic bracing structures 32, the interconnected first primary support units 35 comprise one blind first primary support unit 56 which is not able to support a primary pressure vessel 2. Instead of a blind first primary support unit 56, it is also possible to use an empty first primary support unit 35 which does not support a primary pressure vessel 2. The interconnected second primary support units 36 are connected to the other shared seismic bracing structure 34 and to the interconnected second secondary support units 38 of the secondary module 43 via bolted connections. This step is repeated in the FIGS. 6C and 6D, with the addition that the interconnected first primary support units 35 placed on top of the interconnected first primary support units 35 of the previous module may also be connected to each other via bolted connections. The interconnected second primary support units 36 placed on top of the interconnected second primary support units 36 of the previous primary module 44 may also be connected to each other via bolted connections.

In FIG. 6E, another primary module 44 is hoisted by the same hoisting equipment 45 to place the primary module 44 in position for the construction of the primary support 13 and the shared support 15. This primary module 44 differs from the one used in the FIGS. 6B-D in that it does not contain a blind first primary support unit 56 (or an empty first primary support unit 35). All the first primary support units 35 support one of the primary pressure vessels 2. The interconnected first primary support units 35 are connected to both the primary seismic bracing structures 32. The interconnected first primary support units 35 placed on top of the interconnected first primary support units 35 of the previous module may also be connected to each other. The interconnected second primary support units 36 are connected to both the shared seismic bracing structures 34. In addition, the second primary support unit 36 placed on top of one of the second secondary support units 38 of the secondary module 43, may be connect to said second secondary support unit 38. The interconnected second primary support units 36 placed on top of the interconnected second primary support units 36 of the previous primary module 44 may also be connected to each other. This step is repeated in FIG. 6F with the difference that the interconnected second primary support units 36 are placed only on top of (and may be connected to) the interconnected second primary support units 36 of the previous primary module 44.

After that, yet another primary module 44 is hoisted by the same hoisting equipment 45 to place the primary module 44 in position for the construction of the primary support 13 and the shared support 15. This primary module 44 differs from the one used in the FIGS. 6E and 6F in that it contains two empty first primary support units 35 and two empty second primary support units 36. The empty first primary support units 35 and the empty second primary support units 36 do not support a primary pressure vessel 2. The interconnected first primary support units 35 are not connected to the primary seismic bracing structures 32. The interconnected first primary support units 35 placed on top of the interconnected first primary support units 35 of the previous module are connected to each other. The interconnected second primary support units 36 are not connected to the shared seismic bracing structures 34. The interconnected second primary support units 36 placed on top of the interconnected second primary support units 36 of the previous primary module 44 are connected to each other. This way, the storage assembly of the FIGS. 1A and 1B is produced.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

It will be apparent to those skilled in the art that various modifications can be made to the storage assembly and the method without departing from the scope as defined in the claims.

1. A storage assembly for storing pressurized fluid, such as hydrogen, which storage assembly comprises:
at least one cylindrical primary pressure vessel configured to store pressurized fluid at a first pressure and comprising a first primary end and an opposite second primary end and having a first longitudinal length,
at least one cylindrical secondary pressure vessel configured to store pressurized fluid at a second pressure being higher than the first pressure and comprising a first secondary end and an opposite second secondary end and having a second longitudinal length being smaller than the first longitudinal length,
a primary support supporting the at least one cylindrical primary pressure vessel near or at the first primary end,
a secondary support supporting the at least one cylindrical secondary pressure vessel near or at the first secondary end, and
a shared support supporting the at least one cylindrical primary pressure vessel near or at the second primary end and supporting the at least one cylindrical secondary pressure vessel near or at the second secondary end.

2. The storage assembly according to claim 1, wherein the second pressure is between, and including, 1.5 and 3 times higher than the first pressure.

3. The storage assembly according to claim 1, wherein:
the cylindrical primary pressure vessel comprises a primary vessel wall defining a primary inner diameter and having a primary wall thickness, and
the cylindrical secondary pressure vessel comprises a secondary vessel wall defining a secondary inner diameter and having a secondary wall thickness, and
a secondary ratio defined by the secondary wall thickness divided by the secondary inner diameter is larger than a primary ratio defined by the primary wall thickness divided by the primary inner diameter.

4. The storage assembly according to claim 3, wherein the secondary wall thickness is larger than the primary wall thickness.

5. The storage assembly according to claim 3, wherein the secondary inner diameter is equal to or smaller than the primary inner diameter.

6. The storage assembly according to claim 1, wherein the at least one cylindrical primary pressure vessel and the at least one cylindrical secondary pressure vessel extend in a same direction away from the shared support.

7. The storage assembly according to claim 1, wherein:
at least one cylindrical primary pressure vessel is positioned above at least one cylindrical secondary pressure vessel, and
the secondary support is located within a footprint area defined by the shared support and the primary support.

8. The storage assembly according to claim 1, wherein the storage assembly further comprises a first lateral side and a second lateral side, and the at least one cylindrical secondary pressure vessel is located at the first lateral side, the second lateral side, or a combination thereof.

9. The storage assembly according to claim 8, wherein the storage assembly comprises multiple secondary pressure vessels which are positioned on top of each other.

10. The storage assembly according to claim 1, wherein none of the at least one cylindrical primary pressure vessel is positioned below the at least one cylindrical secondary pressure vessel.

11. The storage assembly according to claim 1, wherein the storage assembly comprises multiple cylindrical primary pressure vessels.

12. The storage assembly according to claim 1, wherein the primary support comprises a primary seismic bracing structure, the secondary support comprises a secondary seismic bracing structure, and the shared support comprises a shared seismic bracing structure.

13. The storage assembly according to claim 1, wherein:
each at least one cylindrical primary pressure vessel is supported near or at the first primary end by a first primary support unit and is supported near or at the second primary end by a second primary support unit,
each at least one cylindrical secondary pressure vessel is supported near or at the first secondary end by a first secondary support unit and is supported near or at the second secondary end by a second secondary support unit,
said first primary support unit forms part of the primary support,
said first secondary support unit forms part of the secondary support, and
said second primary support unit and said second secondary support unit form part of the shared support.

14. The storage assembly according to claim 13, wherein:
the storage assembly comprises multiple cylindrical secondary pressure vessels, and
each first secondary support unit supporting the multiple cylindrical secondary pressure vessels are interconnected and each second secondary support unit supporting the multiple cylindrical secondary pressure vessels are interconnected.

15. The storage assembly according to claim 13, wherein:
at least one first secondary support unit comprises a first secondary hoisting member or is configured to be coupled to a removable first secondary hoisting member,
at least one second secondary support unit comprises a second secondary hoisting member or is configured to be coupled to a removable second secondary hoisting member, and
the first secondary hoisting member or the removable first secondary hoisting member, and the second secondary hoisting member or the removable second secondary hoisting member are configured to be attached to a hoisting equipment and hoisted while the first secondary support unit and the second secondary support unit support the respective cylindrical secondary pressure vessel.

16. A method for producing a storage assembly of claim 1, wherein said method comprises:
providing the primary support supporting the at least one cylindrical primary pressure vessel near or at the first primary end,
providing the secondary support supporting the at least one cylindrical secondary pressure vessel near or at the first secondary end, and
providing the shared support supporting the at least one cylindrical primary pressure vessel near or at the second primary end and supporting the at least one cylindrical secondary pressure vessel near or at the second secondary end.

17. The method according to claim 16 for producing a storage assembly, wherein said method comprises:
for each at least one cylindrical primary pressure vessel, providing a first primary support unit supporting said cylindrical primary pressure vessel to construct the primary support,
for each at least one cylindrical secondary pressure vessel, providing a first secondary support unit supporting said cylindrical secondary pressure vessel to construct the secondary support, and
for each at least one cylindrical primary pressure vessel, providing a second primary support unit of said cylindrical primary pressure vessel, and for each of the at least one cylindrical secondary pressure vessel providing a second secondary support unit of said cylindrical secondary pressure vessel to construct the shared support.

18. The method according to claim 16 for producing a storage assembly wherein each at least one cylindrical secondary pressure vessel is supported near or at the first secondary end by a first secondary support unit and is supported near or at the second secondary end by a second secondary support unit, wherein said method comprises:
pre-assembling a secondary module by interconnecting each first secondary support unit supporting the at least one cylindrical secondary pressure vessel and by interconnecting each second secondary support unit supporting the at least one cylindrical secondary pressure vessel,
providing the secondary module to construct the secondary support with each interconnected first secondary support unit and to construct the shared support with each interconnected second secondary support unit.

19. The method according to claim 16 for producing a storage assembly wherein each at least one cylindrical secondary pressure vessel is supported near or at the first secondary end by a first secondary support unit and is supported near or at the second secondary end by a second secondary support unit, wherein said method comprises providing a secondary module formed by interconnecting each first secondary support unit supporting the at least one cylindrical secondary pressure vessel and by interconnecting each second secondary support unit supporting the at least one cylindrical secondary pressure vessel to construct the secondary support with each interconnected first secondary support unit and to construct the shared support with each interconnected second secondary support unit.

20. The method according to claim 16 for producing a storage assembly, wherein said method comprises hoisting the at least one cylindrical secondary pressure vessel being supported by a first secondary support unit provided with a first secondary hoisting member or a removable first secondary hoisting member, and by a second secondary support unit provided with a second secondary hoisting member or a removable second secondary hoisting member with a hoisting equipment attached to said first secondary hoisting member or the removable first secondary hoisting member, and said second secondary hoisting member or the removable second secondary hoisting member in order to construct the secondary support and the shared support.

21. The method according to claim 20,
wherein the first secondary support unit of a secondary module is provided with the first secondary hoisting member or the removable first secondary hoisting member, and one of the second secondary support unit of a secondary module is provided with the second secondary hoisting member or the removable second secondary hoisting member, and said method comprises hoisting the secondary module with the hoisting equipment attached to said first secondary hoisting member or the removable first secondary hoisting member, and said second secondary hoisting member or the removable second secondary hoisting member in order to construct the secondary support and the shared support.
